(19) United States
(12) Patent Application Publication
(10) Pub. No.: US 2020/0014249 A1
(43) Pub. Date: Jan. 9, 2020

(54) METHOD FOR OPERATING AN INDUCTIVE CHARGING DEVICE

(71) Applicant: Robert Bosch GmbH, Stuttgart (DE)

(72) Inventors: Martin Gonda, Buehl (DE); Dragan Krupezevic, Stuttgart (DE); Juergen Mack, Goeppingen (DE)

(21) Appl. No.: 16/484,610

(22) PCT Filed: Feb. 1, 2018
(86) PCT No.: PCT/EP2018/052500

§ 371 Date: Aug. 8, 2019

(30) Foreign Application Priority Data
Feb. 10, 2017 (DE) 10 2017 202 162.4
Aug. 23, 2017 (DE) 10 2017 214 747.4

(51) Int. Cl. H02J 50/60; H02J 7/02; G01V 3/10

(52) U.S. Cl. CPC H02J 50/60; G01V 3/102; H02J 7/025

(57) ABSTRACT

A method for operating an inductive charging device, in which a foreign object detection is carried out in at least one method step. It is provided that in at least one method step, the foreign object detection is carried out as a function of at least one characteristic power transmission variable.

### BACKGROUND INFORMATION

Methods for operating an inductive charging device, in which a foreign object detection is carried out in at least one method step, are conventional.

### SUMMARY

The present invention is based on a method for operating an inductive charging device, in which a foreign object detection is carried out in at least one method step.

It is provided that the foreign object detection is carried out in at least one method step as a function of at least one characteristic power transmission variable. This advantageously makes it possible to minimize interruptions in a charging operation on account of a foreign object detection. Long charge cycles are advantageously achievable. A short charge period is advantageously able to be realized. In an advantageous manner, it is possible to consider a risk of damage to an inductive charging device while carrying out a foreign object detection.

An “inductive charging device” particularly is to be understood as a device for charging battery-powered devices, especially accumulators. The device preferably includes at least one open-loop and/or closed-loop control unit, which is at least provided to control and/or regulate a charging operation. In particular, it preferably is a charging device which is provided to inductively transmit charge energy to at least one battery-powered device during a charging operation. A “charging operation” in particular means an operating state during which the battery-powered device is provided with energy from the outside. Preferably, this particularly describes an operating state during which the battery-powered device temporarily stores externally supplied energy. A “battery-powered device” in particular is to be understood as a device for the temporary storage of electrical energy, in particular an accumulator. More specifically, it preferably describes a rechargeable energy store. Possible are different battery-powered devices that appear useful to one skilled in the art, but the device is to be understood as a lithium-ion accumulator, in particular.

In addition, an “open-loop and/or closed-loop control unit” in particular should be understood as a unit having at least one control electronics system. A “control electronics system” especially describes a unit provided with a processor unit and a memory unit as well as an operating program stored in the memory unit. “Provided” in particular means specially programmed, configured and/or developed. More specifically, the expression that an object is provided for a specific function should be understood to express that the object fulfills and/or executes this specific function in at least one application and/or operating state.

A “foreign object detection” in particular describes a detection of and/or a check for the presence of foreign objects, in particular in an environment of the inductive charging device and/or the battery-powered device. In particular, it should preferably be understood as the detection of and/or the check for the presence of foreign objects which are located in a contact region between the inductive charging device and a battery-powered device and may have a detrimental effect on a charging operation during a charging process. “Foreign objects” in particular are meant to denote metallic and/or magnetic components, partial pieces or other objects.

A “characteristic power transmission variable” in particular describes a characteristic variable which characterizes, preferably in quantitative terms, an electromagnetic flow of energy between the inductive charging device and a battery-powered device to be charged during a charging operation. The characteristic power transmission variable is preferably developed as a power that is transmitted between the inductive charging device and a battery-powered device to be charged, as an electrical current in a charging coil, an electric voltage applied to a charging coil, a temperature of a charging coil, power accepted by a power supply unit, a coupling factor between inductively coupled charging coils, or some other characteristic power transmission variable considered useful by one skilled in the art.

In addition, the inductive charging device preferably includes at least one sensor unit for at least detecting the at least one characteristic power transmission variable. In this context, a “sensor unit” in particular describes a unit which is provided to record at least one characteristic variable and/or one physical property; the recording may be carried out actively, e.g., in particular by generating and outputting an electrical measuring signal, and/or passively, e.g., in particular by detecting changes in the properties of a sensor component. More specifically, the sensor unit is provided to detect the at least one characteristic power transmission variable during a charging operation in a continuous or quasi-continuous manner.

It is furthermore provided that in at least one method step, at least one characteristic precision variable of the foreign object detection is determined as a function of the at least one characteristic power transmission variable. This advantageously makes it possible to achieve a simplified execution of a foreign object detection. Interruptions in a charging operation on account of a foreign object detection may advantageously be kept to a minimum. Long charge cycles are able to be achieved in an advantageous manner. A short charge period is advantageously realizable. A “characteristic precision variable” in particular should be understood as a characteristic variable which at least partially characterizes a precision of the foreign object detection. Preferably, the characteristic precision variable is developed as a number of discrete frequency points, a number of sweep cycles, or as some other characteristic precision variable considered meaningful by one skilled in the art.

It is furthermore provided that in at least one method step, at least one execution frequency of the foreign object detection is determined as a function of the at least one characteristic power transmission variable. This advantageously makes it possible to keep the number of executions of a foreign object detection to a minimum. Interruptions in a charging operation on account of a foreign object detection are advantageously minimizable. In an advantageous manner, long charge cycles are achievable, and a short charge period is advantageously able to be realized. In this context, an “execution frequency” is particularly to be understood as a frequency of an execution of the foreign object detection during a charging operation. More specifically, the execution frequency during a charging operation involving a medium power transmission, e.g., a power transmission of between 5 W and 10 W, may be reduced in comparison with an execution frequency of a charging operation involving a high power transmission, e.g., a power transmission of more than 10 W. During charging operations involving a low power transmission, an execution of a foreign object detection may be dispensed with completely.

In addition, it is provided that in at least one method step, the foreign object detection is carried out as a function of at least one change over time, in particular of an amplitude fluctuation and/or a gradient, of the characteristic power transmission variable. This advantageously makes it possible to achieve a low risk of damage to an inductive charging device. Interruptions in a charging operation on account of a foreign object detection may advantageously be kept to a minimum. In an advantageous manner, long charge cycles are achievable. A short charge period is advantageously able to be realized. An “amplitude fluctuation” in particular is to be understood as a difference between a maximum and a minimum value of a characteristic variable varying over time. A “gradient” in particular means a measure of an increase or decrease in a value over time of a characteristic variable varying over time, preferably an ascending slope of a tangent.

Moreover, it is advantageously provided that in at least one method step, the foreign object detection is suspended as a function of an undershooting of a limit value, in particular a lower limit value, by a value of the characteristic power transmission variable, in particular an undershooting of a limit value of a transmitted power and/or a current in an excitation coil. This advantageously makes it possible to avoid interruptions in a charging operation on account of a foreign object detection. Long charge cycles are advantageously achievable. A short charge period is advantageously able to be realized.

In addition, it is provided that in at least one method step, the foreign object detection is carried out as a function of an exceeding of a limit value, in particular an upper limit value, by a value of the characteristic power transmission variable, in particular an exceeding of a limit value of a transmitted power and/or a current in an excitation coil. This advantageously makes it possible to restrict interruptions in a charging operation on account of a foreign object detection to cases in which there is a risk of damage to an inductive charging device. In an advantageous manner, long charge cycles are achievable. A short charge period may advantageously be realized. A low risk of damage to an inductive charging device is able to be achieved.

Furthermore, it is provided that in at least one method step, at least one execution period of time of the foreign object detection is determined as a function of the at least one characteristic power transmission variable. In an advantageous manner, this makes it possible to keep interruptions in a charging operation on account of a foreign object detection as short as possible. Long charge cycles are advantageously achievable. In an advantageous manner, a short charge period is able to be realized. An “execution period” in particular may be understood as a length in time of a sweep and/or a sweep cycle. In particular, the swept frequency range and/or the number of discrete frequency points of a sweep is/are able to be varied in order to adapt the execution period of the foreign object detection.

In addition, an inductive charging device is provided, in particular for executing a method according to the present invention, which has at least one open-loop and/or closed-loop control unit, the open-loop and/or closed-loop control unit being provided at least to carry out a foreign object detection as a function of at least one characteristic power transmission variable. This advantageously makes it possible to minimize interruptions in a charging operation on account of a foreign object detection. Long charge cycles are advantageously achievable. In an advantageous manner, a short charge period is able to be realized. This advantageously makes it possible to consider a risk of damage to an inductive charging device when executing a foreign object detection.

It is furthermore provided that the open-loop and/or closed-loop control unit of the inductive charging device is at least provided to determine at least one characteristic precision variable of the foreign object detection as a function of at least one characteristic power transmission variable. This advantageously makes it possible to achieve a simplified execution of a foreign object detection. Interruptions in a charging operation on account of a foreign object detection are advantageously able to be kept to a minimum. Long charge cycles are advantageously achievable, and a short charge period is able to be realized in an advantageous manner.

Moreover, it is provided that the open-loop and/or closed-loop control unit of the inductive charging device is at least provided to determine at least one execution frequency of the foreign object detection as a function of the at least one characteristic power transmission variable. This advantageously makes it possible to keep the number of executions of a foreign object detection to a minimum. Interruptions in a charging operation on account of a foreign object detection are advantageously kept low. In an advantageous manner, long charge cycles are able to be achieved.

The method according to the present invention and/or the inductive charging device according to the present invention is/are not meant to be restricted to the afore-described application and specific embodiment. In particular, in order to fulfill a method of functioning as described herein, the method according to the present invention and/or the inductive charging device according to the present invention may have a number of individual elements, components and units as well as method steps that deviates from the number mentioned herein. In addition, the disclosed features of the inductive charging device according to the present invention are similarly to be read as applying to the present method as well. Moreover, in the value ranges indicated in this disclosure, values that lie within the mentioned limits are also to be considered disclosed and usable as desired.

### BRIEF DESCRIPTION OF THE DRAWINGS

Additional advantages result from the following description of the figures. The figures illustrate an exemplary embodiment of the present invention. The figures and the description of the figures include numerous features in combination. One skilled in the art will expediently also consider the features in isolation and combine them to form additional meaningful combinations.

FIG. 1 shows an inductive charging device in a schematic representation.

FIG. 2 shows a flow diagram of a method according to the present invention in a schematic representation.

### DETAILED DESCRIPTION OF EXAMPLE EMBODIMENTS

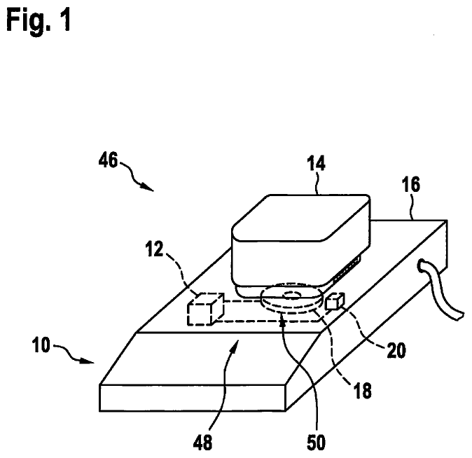

FIG. 1 shows an inductive charging device 10. In addition, FIG. 1 shows a battery-powered device 14 to be charged. Inductive charging device 10 is provided to charge battery-powered device 14. Inductive charging device 10 forms the primary side of a charge system 46. A rechargeable battery of a handheld tool represents battery-powered device 14 to be charged. However, it is also possible to use inductive charging device 10 for charging other rechargeable batteries that one skilled in the art might consider useful. FIG. 1 shows inductive charging device 10 and battery-powered device 14 to be charged during a charging operation. Battery-powered device 14 is placed on a top surface of a housing 16 of inductive charging device 10 and is wirelessly charged by way of a charging coil 18 of inductive charging device 10.

Inductive charging device 10 includes an open-loop and/or closed-loop control unit 12. Inductive charging device 10 has a charge electronics unit 48, which encompasses open-loop and/or closed-loop control unit 12. In addition, charge electronics unit 48 has an oscillating circuit 50. Oscillating circuit 50 includes charging coil 18.

During a charging operation of inductive charging device 10, a foreign object detection is carried out as a function of at least one characteristic power transmission variable. It is checked during the foreign object detection whether foreign objects that may have an adverse effect on a charging operation are located between inductive charging device 10 and battery-powered device 14 or are simply located only on inductive charging device 10 or may pose a risk to an operator or to inductive charging device 10. The foreign object detection is carried out in inductive charging device 10 using a method for foreign object detection with the aid of open-loop and/or closed-loop control unit 12 of inductive charging device 10. Open-loop and/or closed-loop control unit 12 of inductive charging device 10 is provided to execute the foreign object detection during a charging operation as a function of at least one characteristic power transmission variable.

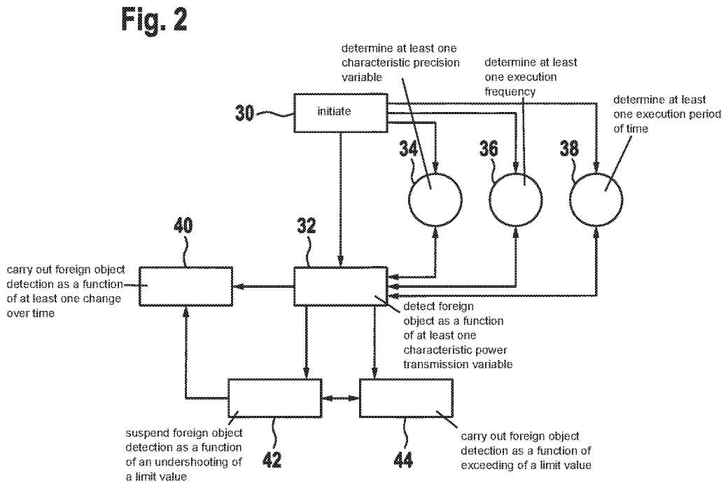

FIG. 2 shows a flow diagram of a method for foreign object detection during a charging operation of the inductive charging device. In a first method step 30, the foreign object detection is initiated by open-loop and/or closed-loop control unit 12. The subsequent further execution of the foreign object detection takes place in a further method step 32 as a function of at least one characteristic power transmission variable. The characteristic power transmission variable in particular is a characteristic variable that characterizes, preferably in quantitative terms, an electromagnetic energy flow which is taking place during a charging operation between inductive charging device 10 and battery-powered device 14 to be charged. The characteristic power transmission variable is preferably developed as an electric power transmitted between inductive charging device 10 and battery-powered device 14 to be charged, as an electric current in a charging coil 18, an electric voltage applied at a charging coil 18, a temperature of a charging coil 18, an accepted power by a power supply unit, or the like. Closed-loop and/or open-loop control unit 12 has a sensor unit 20, which is provided to detect the characteristic power transmission variable during a charging operation of the inductive charging device in a continuous or quasi-continuous manner.

To optimize the foreign object detection, different parameters for adjusting the foreign object detection are able to be determined from the characteristic transmission power value with the aid of open-loop and/or closed-loop control unit 12. In at least one method step 34, at least one characteristic precision variable, such as a number of discrete frequency points and/or a number of sweep cycles, of the foreign object detection is determined as a function of the at least one characteristic power transmission variable. In at least one method step 36, at least one execution frequency, in particular a frequency of an execution of the foreign object detection during a charging operation, of the foreign object detection is determined as a function of the at least one characteristic power transmission variable. In particular, the execution frequency during a charging operation involving an average power transmission, e.g. a power transmission of between 5 W and 10 W, may be reduced in comparison with an execution frequency during a charging operation involving a high power transmission, e.g., a power transmission of more than 10 W. During charging operations that feature a low power transmission, an execution of a foreign object detection may be dispensed with completely. In at least one method step 38, at least one execution period of time, in particular a length of time of a sweep and/or a sweep cycle, of the foreign object detection is determined as a function of the at least one characteristic power transmission variable. Method steps 34, 36, 38 for determining parameters for the adjustment of the foreign object detection are able to be carried out in combination or individually.

Furthermore, in at least one method step 40, the foreign object detection is carried out as a function of at least one change over time, in particular of an amplitude fluctuation and/or a gradient, of the characteristic power transmission variable. In particular, a complete foreign object detection may be carried out once during the initialization of the charging operation. If no a fault occurs during the run through, then the foreign object detection is deactivated and the charging operation, during which energy from inductive charging device 10 is transmitted to battery-operated device 14, is started. During the energy transmission, open-loop and/or closed-loop control unit 12 monitors the charging operation for irregularities. If open-loop and/or closed-loop control unit 12 detects a change over time, in particular of an amplitude fluctuation and/or a gradient, of the characteristic power transmission variable, then the charging operation is interrupted and a foreign object detection initiated.

In at least one method step 42, the foreign object detection is suspended as a function of an undershooting of a limit value, in particular an undershooting of a lower limit value, by a value of the characteristic power transmission variable. In at least one method step 44, the foreign object detection is carried out as a function of an exceeding of a limit value, in particular an exceeding of an upper limit value, by a value of the characteristic power transmission variable. In particular, the execution of the foreign object detection of a charging operation is suspended when a lower limit value of a power transmission is undershot, for instance in a drop of the power transmission to a value below 5 W. When a specified limit value of the power transmission is exceeded, the foreign object detection is resumed again.

1-10. (canceled)

11. A method for operating an inductive charging device, comprising:
detecting, by the inducting charging device, a foreign object detection, the detecting being carried out as a function of at least one characteristic power transmission variable.

12. The method as recited in claim 11, further comprising:
determining at least one characteristic precision variable of the foreign object detection as a function of the at least one characteristic power transmission variable.

13. The method as recited in claim 11, further comprising:
determining at least one execution frequency of the foreign object detection as a function of the at least one characteristic power transmission variable.

14. The method as recited in claim 11, wherein the foreign object detection is carried out as a function of at least one change over time of an amplitude fluctuation and/or a gradient, of the characteristic power transmission variable.

15. The method as recited in claim 11, further comprising:
suspending the foreign object detection as a function of a value of the characteristic power transmission variable undershooting a limit value.

16. The method as recited in claim 11, wherein the foreign object detection is carried out as a function of a value of the characteristic power transmission variable exceeding a limit value.

17. The method as recited in claim 1, further comprising:
determining at least one execution period of time of the foreign object detection as a function of the at least one characteristic power transmission variable.

18. An inductive charging device, comprising:
at least one open-loop and/or closed-loop control unit configure to carry out a foreign object detection as a function of at least one characteristic power transmission variable.

19. The inductive charging device as recited in claim 18, wherein the open-loop and/or closed-loop control unit is configured to determine at least one characteristic precision variable of the foreign object detection as a function of at least one characteristic power transmission variable.

20. The inductive charging device as recited in claim 18, wherein the open-loop and/or closed-loop control unit is configured to determine at least one execution frequency of the foreign object detection as a function of the at least one characteristic power transmission variable.
